(19) United States
(12) Patent Application Publication
(10) Pub. No.: US 2015/0180266 A1
(43) Pub. Date: Jun. 25, 2015

(54) WIRELESS CHARGING OPTIMIZATION

(71) Applicant: CAMBRIDGE SILICON RADIO LIMITED, Cambridge (GB)

(72) Inventor: Anthony Lawrence MCFARTHING, Cambridgeshire (GB)

(73) Assignee: CAMBRIDGE SILICON RADIO LIMITED, Cambridge (GB)

(21) Appl. No.: 14/138,393

(22) Filed: Dec. 23, 2013

(51) Int. Cl. H02J 7/02; H02J 7/00

(52) U.S. Cl. CPC H02J 7/025; H02J 7/0047; H02J 7/007; H02J 7/0052

(57) ABSTRACT

Wireless charging methods and apparatus are disclosed, including a wireless charging method comprising transmitting a wireless charging signal using an antenna, determining an indication of power being transferred to at least one device being charged by the wireless charging signal, adjusting an impedance of the antenna to increase the power being transferred.

### TECHNICAL FIELD

Embodiments of the invention described herein relate to wireless charging and in particular for example the optimization of power transfer between a wireless charger and a device being charged.

### BACKGROUND

Wireless charging of an electronic device is a desirable convenience as the requirement to physically connect the device to a wire, dock or other physical component while charging is removed.

Some devices are capable of communicating with each other according to the near-field communication (NFC Forum or ISO14443) standard or radio frequency identification (RFID) standard. According to these standards, one device (a reader) can communicate with another device (a tag). The tag may also harvest power from a signal transmitted by the reader, so that the tag may not require any other power source. The tag device has an antenna that is resonant at a frequency on which NFC (or RFID) communications are transmitted from the reader in order to be able to receive as much energy as possible from the signal. This allows the tag to extract as much energy as possible for powering the device as well as ensuring communication reliability.

### SUMMARY OF EMBODIMENTS OF THE INVENTION

According to a first aspect of embodiments of the invention, there is provided a wireless charging method comprising transmitting a wireless charging signal using an antenna, determining an indication of power being transferred to at least one device being charged by the wireless charging signal, and adjusting an impedance of the antenna to increase the power being transferred.

According to a second aspect of embodiments of the invention, there is provided a wireless charger comprising an antenna, a transmitter coupled to the antenna for transmitting a wireless charging signal, measurement apparatus for determining an indication of power being transferred to at least one device being charged by the wireless charging signal, and a processor for adjusting an impedance of the antenna to increase the power being transferred.

### BRIEF DESCRIPTION OF THE FIGURES

Embodiments of the invention will now be described by way of example only, in which:

FIG. 1 shows a wireless charging system according to embodiments of the invention; and

FIG. 2 shows an example of power transfer against coupling factor for certain configurations of the wireless charging system.

### DETAILED DESCRIPTION OF EMBODIMENTS OF THE INVENTION

Some NFC or RFID capable devices may be associated with a battery. The battery may be present for example to power the device when not enough power is being extracted from a signal transmitted from a reader (or other NFC or RFID device), or when no such signal is being transmitted. Additionally or alternatively, for example, the NFC or RFID device may be associated with another device such as a mobile telephone that is typically powered by a battery. The device is thus NFC or RFID capable.

Specific embodiments described below relate to NFC although the principles disclosed herein may also be applied to other wireless charging and communication technologies (for example, RFID).

NFC Wireless Charging (NFC WC) could be used to charge NFC or RFID capable devices that also include a battery. An NFC charging device, which in some cases may also be an NFC reader, may transmit a wireless charging signal on a frequency typically used for NFC communications, such as 13.56 or 6.78 MHz, 1 though any frequency may be used with the same or other wireless communication technologies. A wireless charging signal is a signal with a power higher than that typically expected from a reader device when powering tags for communication purposes and not for charging a battery. An example of the power of a wireless charging signal is 10 W although other power levels are possible whereas a reader might only transfer powers less than 100 mW.

The power transferred between a wireless charger antenna and an antenna on a device being charged is dependent on a number of factors. In particular, the power transferred depends on the value of a coupling factor between the antennas (between 0 and 1, typically between 0.05 and 0.5 when the charger and device are in close proximity). The value of the coupling factor depends on the relative position of the charger and the device being charged. Typically, there is an optimum position and orientation for the device being charged relative to the charger. If the device is not in this position and/or orientation, the power transferred from the charger to the device may be reduced and the wireless charging may become less efficient.

Similarly, for a given relative position of the charger and device, there is an optimum load impedance for the charger power amplifier (PA) that maximizes the coupling factor between them in that position and thus maximizes the power transferred between them by a wireless charging signal. One way of achieving this is to adjust the input impedance of the charger antenna such that the impedance of the load on the power amplifier of the wireless charger (i.e. when one or more devices are being charged) matches or is close to the optimum load value for the power amplifier in the charger, which may be and very often is 50 ohms for PAs although there is no absolute necessity for this value.

Embodiments of the present invention as described herein seek to increase or even maximize the power transferred from a charger to a device being charged regardless of the position and/or orientation of the device relative to the charger by adjusting the impedance of the antenna of the charger to be closer to the optimum impedance, thus increasing or even maximizing the efficiency of power transfer.

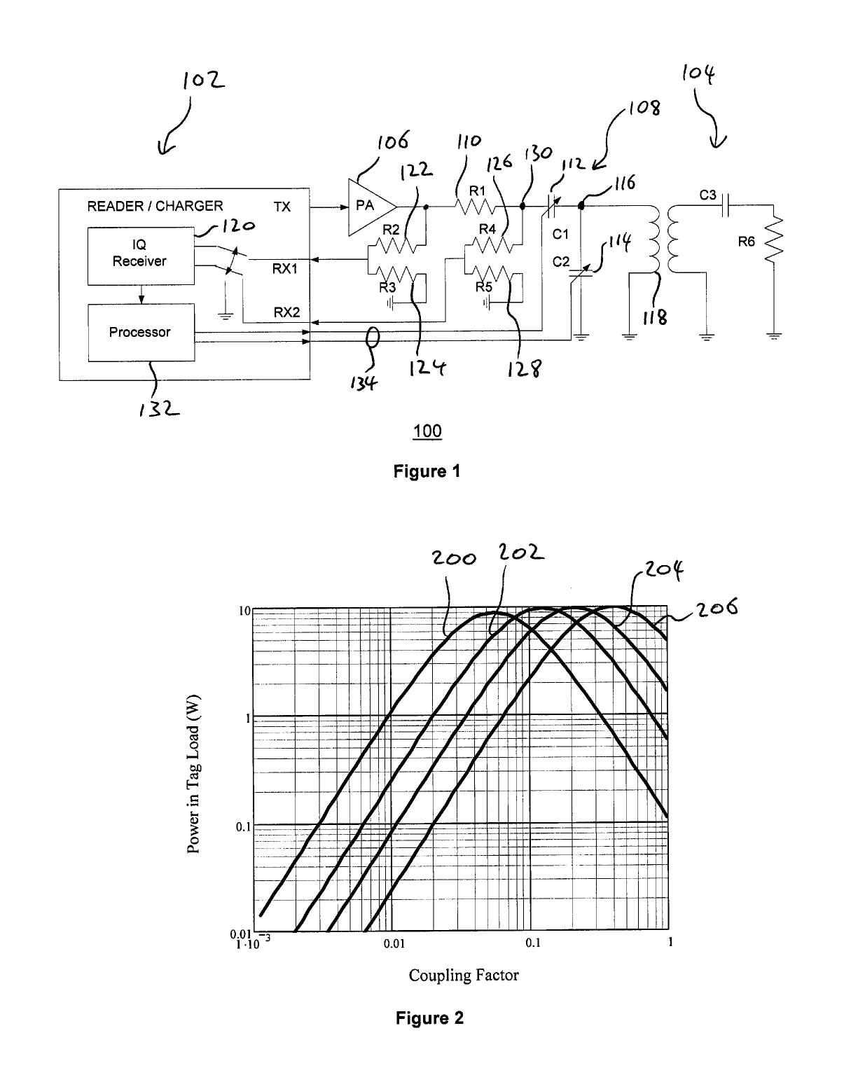

FIG. 1 shows an example of a wireless charging system 100 in accordance with embodiments of the invention. The system 100 includes a NFC wireless charger 102, which can transmit a wireless charging signal at the NFC frequency 13.56 MHz, and a device being charged 104 such as a NFC tag. Other frequencies are also possible including, for example, the frequency used by A4WP, 6.78 MHz. The charger 102 includes a transmitter that provides a signal to be transmitted to a power amplifier 106. The signal to be transmitted may be a wireless charging signal for transferring power from the charger 102 to the device 104 (and possibly additional devices). In some embodiments, or at certain times, the wireless charging signal may be modulated (for example, amplitude modulated) by an information signal by the transmitter.

The output from the power amplifier 106 is provided to an antenna 108 via a resistor 110 connected in series with the antenna. The antenna comprises a variable capacitive divider comprising capacitors 112 and 114 connected in series between the resistor 110 and ground. The capacitive divider defines a node 116 between the capacitors 112 and 114. An inductance 118 represents an inductive part of the antenna for transmitting the signal from the power amplifier 106. In some alternative embodiments, a balanced output power amplifier might be used in which case this circuit would then become the balanced equivalent. In this type of design the ground connection on the inductive part 118 would instead be connected to a second driven point.

The charger 102 also includes an IQ receiver 120. The IQ receiver 120 includes two inputs. A first input is selectively connected to either a node RX1 and a node RX2, and a second input is selectively connected to either the node RX2 or ground.

The node RX1 is connected to the mid point of a potential divider comprising resistors 122 and 124 that are connected in series between the output of the power amplifier 106 and ground. The node RX2 is connected to the mid point of a potential divider comprising resistors 126 and 128 connected in series between a node 130 and ground. The node 130 is between the resistor 110 and the variable capacitor 112.

The charger 102 includes a processor 132 that receives a signal from the IQ receiver 120. The processor 132 can control the variable capacitors 112 and 114 individually via control lines 134.

In some embodiments, the IQ receiver and/or processor 132 monitors the signal being output from the power amplifier 106 and provided to the antenna 108. For example, characteristics of the signal may be monitored, such as the voltage and current of the signal.

In some embodiments, the IQ receiver 120 monitors the current as follows. In a current monitoring mode the first input of the IQ receiver is connected to the node RX1 and the second input is connected to the node RX2. The potential divider formed by resistors 122 and 124 provides a voltage at RX1 that is proportional to the power amplifier 106 output voltage. The potential divider formed by resistors 126 and 128 provides a voltage at RX2 that is proportional to the voltage at the node 130. The difference between these two voltages represents (for example, is proportional to) the voltage across the resistor 110, and thus is proportional to the current flowing through the resistor 110, and the current in the antenna 130. The phase of this current signal can be measured by the IQ receiver 120 in a conventional manner with respect to the phase of the IQ receiver's synchronous local oscillator, LO, (not shown) and an indication of such can be provided to the processor 132.

In some embodiments, the IQ receiver 120 measures the voltage whereby the first input of the IQ receiver 120 is connected to the node RX2 and the second input is connected to ground. Thus, the voltage at the node RX2 and the first input of the IQ receiver 120 is proportional to the voltage being provided to the antenna 108. In some embodiments, the resistor 110 is a “low value” resistor, such that little power is dissipated by the resistor. In one example embodiment, where the power amplifier 106 provides a signal of 10 W power, the peak voltage may be 31V. The input to the receiver (for example, the first or second input) may need to be up to 1V, for example. Thus, the resistor 110 may be chosen to be around 1 ohm, and the resistors 122 and 126 may be 5 kohm. The potential dividers may be arranged to drop the voltages around the resistor 110 by a factor of around 1:30, for example.

The IQ receiver 120 can then measure the phase of the voltage of the signal in a conventional manner as before with respect to the phase of the IQ receiver's synchronous LO and provide an indication of such to the processor 132.

Thus, the processor has indications of the phases of the voltage and current of the signal being provided to the antenna. From this, in some embodiments the processor can determine the impedance of the load on the power amplifier 106. The IQ receiver gain may not be known accurately but the impedance of the antenna will be the ratio of the vector quantities V/I and so receiver gain does not need to be known for impedance to be determined accurately.

The processor may then adjust the variable capacitance of the capacitor 112 and/or the capacitor 114 to increase the power being transferred to the tag 104. This can be done for example by adjusting the impedance matching capacitors so that the impedance of the load on the power amplifier 106 is closer to or even is substantially equal to a target impedance. The target impedance may be for example the impedance of the load that corresponds to the maximum power transfer between the charger and device or devices being charged. In some embodiments, the target impedance may be the ideal load impedance of the power amplifier, such as 50 ohms Therefore, the processor may adjust the impedance of the load using the variable capacitors to be closer to or substantially equal to 50 ohms. The example of a 50 ohms load impedance has no reactance, thus the processor 132 adjusts the variable capacitors to adjust both the resistance and the reactance of the load impedance. However, in alternative embodiments the processor 132 may adjust either the resistive part or the reactive part of the impedance. For example, the processor 132 may adjust the variable capacitances such that the resistive component of the load impedance is closer to or substantially equal to 50 ohms, or such that the reactive component of the load impedance is closer to or substantially equal to zero.

In alternative embodiments, the processor may measure other characteristics of the signal or components of the charger and adjust the capacitances accordingly. For example, as indicated above, the processor adjusts the capacitors based on measurements of the voltage and current of the signal being supplied to the antenna, though in other embodiments the adjustment could be made instead on the basis of, for example, the impedance measured in other ways, the power (such as or average or peak power), or some other characteristics of the signal.

FIG. 2 shows an example of the power transferred to an NFC tag by a charger against coupling factor for various values of the capacitors 112 and 114. A first curve 200 represents the power transferred with a low value of the capacitor 112 and a high value of the capacitor 114. A second curve 202 represents the power transferred with a low-mid value of the capacitor 112 and a high-mid value of the capacitor 114. A third curve 204 represents the power transferred with a high-mid value of the capacitor 112 and a low-mid value of the capacitor 114. Finally, a fourth curve 200 represents the power transferred with a low value of the capacitor 112 and a high value of the capacitor 114. The table below provides examples of capacitance values for the capacitors 112 and 114 in an embodiment where the inductance value of the inductance 118 is chosen to be 2.4 μH.

| Power Transfer Curve | Capacitor 112 (pF) | Capacitor 114 (pF) |
|---|---|---|
| 200 | 7.5 | 50 |
| 202 | 17.5 | 40 |
| 204 | 30 | 27 |
| 206 | 57 | 0 |

It can be seen that for each combination of capacitance values, the peak power transfer occurs at a certain value of coupling factor. Consequently, for a certain value of coupling factor (which depends on the relative positions of the charger and the device being charged), there is a combination of capacitor values that provides the maximum power transfer. Therefore, embodiments of the invention alter the capacitances and thus the impedance of the antenna to achieve a power transfer that is closer to the maximum possible for that coupling factor.

Although embodiments described above use a capacitive divider to adjust the antenna impedance, any other suitable way of adjusting the antenna impedance may be used.

Embodiments of the invention may monitor the signal characteristics or load impedance once when charging commences, or continuously or periodically. Even though a device being charged is not expected to move relative to the charger once charging has commenced, any movement of the device being charged may change the coupling factor and hence the preferred values for the capacitors and hence the load impedance. Thus it may be preferable in some embodiments to monitor the signal characteristics dynamically and then continually adjust the capacitors for optimum power transfer. In other schemes a detected movement may be deemed the necessary cause to end the charging session. Such a movement may be detected by a change in the measured antenna input impedance.

In the embodiment shown in FIG. 1, the IQ receiver 120 measures the current in current monitoring mode then measures the voltage in voltage monitoring mode. These steps may be performed in either order. In other embodiments, however, the current and voltage and their phases may be measured in other ways. For example, the charger may include multiple IQ receivers, one to measure the voltage and one to measure the current for example, and in such embodiments the input switching arrangement may not be necessary. Other ways of measuring the current and voltage or other signal characteristics or the impedance of the load are also envisaged and this disclosure is not limited to any particular way of measuring these.

In some embodiments the processor 132 may calculate the capacitances for the capacitors 112 and 114 based on a measured impedance of the antenna or power amplifier load. Alternatively, for example, the processor may use a look-up table that indicates suitable values. Once the capacitance values have been changed, some embodiments may re-measure voltage and current values and re-calculate the impedance (or use the look up table again) to determine more accurate values for the capacitances, for example. This may be done a predetermined number of times or until a criteria is reached, for example the resistance or capacitance being within a certain range of a target value.

In other embodiments, a successive approach may be implemented. For example, the processor 132 may adjust the capacitance of the capacitor 112 in a positive and negative direction, and the capacitance of the capacitor 114 in a positive and negative direction, and obtain four measurements of the impedance for each scenario. The processor 132 may then adjust the capacitances in the directions that move the impedance towards a target impedance for example. In some embodiments, this process may be repeated, for example by making smaller adjustments, a predetermined number of times or until a criteria is reached, for example the measured impedance being within a certain range of a target value.

The above processes carried out by the processor 132 are illustrative examples and any other suitable method of adjusting the capacitances to increase the power being transferred to a device or devices being charged can be used.

Although methods, devices and electronic components have been disclosed in the context of certain preferred embodiments and examples, it will be understood by those skilled in the art that this disclosure extends beyond the specifically disclosed embodiments to other alternative embodiments and/or uses and obvious modifications and equivalents thereof. In addition, while several variations have been shown and described in detail, other modifications, which are within the scope of this disclosure, will be readily apparent to those of skill in the art. It is also contemplated that various combinations or sub-combinations of the specific features and aspects of the embodiments may be made and still fall within the scope of the disclosure. It should be understood that various features and aspects of the disclosed embodiments can be combined with, or substituted for, one another in order to form varying modes of the disclosed embodiments. Thus, it is intended that the scope of the present invention herein disclosed should not be limited by the particular disclosed embodiments described above, but should be determined only by a fair reading of the claims that follow.

What is claimed is:

1. A wireless charging method comprising:
transmitting a wireless charging signal using an antenna;
determining an indication of power being transferred to at least one device being charged by the wireless charging signal; and
adjusting an impedance of the antenna to increase the power being transferred.

2. The method of claim 1, wherein determining the indication comprises determining characteristics of a signal supplied to the antenna.

3. The method of claim 1, wherein determining the indication comprises determining at least one of a current of a signal supplied to the antenna, the voltage of the signal, the relative phase of the current and the voltage, a power of the signal and the impedance of the antenna.

4. The method of claim 3, wherein determining the current comprises determining a voltage across a resistance that is in series with the antenna.

5. The method of claim 1, wherein adjusting the impedance of the antenna comprises adjusting at least one of a resistance and a reactance of the antenna.

6. The method of claim 1, wherein adjusting the impedance of the antenna comprises maximizing the power being transferred.

7. The method of claim 1, wherein adjusting the impedance of the antenna comprises reducing the reactance of the antenna.

8. The method of claim 1, wherein adjusting the impedance of the antenna comprises adjusting the impedance towards a target impedance or adjusting a load on a power amplifier connected to the antenna towards a target impedance.

9. The method of claim 1, wherein adjusting the impedance of the antenna comprises adjusting a variable capacitive divider coupled to the antenna.

10. A wireless charger comprising:
an antenna;
a transmitter coupled to the antenna for transmitting a wireless charging signal;
measurement apparatus for determining an indication of power being transferred to at least one device being charged by the wireless charging signal; and
a processor for adjusting an impedance of the antenna to increase the power being transferred.

11. The wireless charger of claim 10, wherein the measurement apparatus is arranged to determine the indication by determining characteristics of a signal supplied to the antenna.

12. The wireless charger of claim 10, wherein the measurement apparatus is arranged to determine the indication by determining at least one of a current of a signal supplied to the antenna, the voltage of the signal, the relative phase of the current and the voltage, a power of the signal and the impedance of the antenna.

13. The wireless charger of claim 12, further comprising a resistance in series with the antenna, and wherein the measurement apparatus is arranged to determine the indication by determining a voltage across the resistance.

14. The wireless charger of claim 10, wherein adjusting the impedance of the antenna comprises adjusting at least one of a resistance and a reactance of the antenna.

15. The wireless charger of claim 10, wherein the processor is arranged to adjust the impedance of the antenna to maximize the power being transferred.

16. The wireless charger of claim 10, wherein adjusting the impedance of the antenna comprises reducing the reactance of the antenna.

17. The wireless charger of claim 10, wherein adjusting the impedance of the antenna comprises adjusting the impedance towards a target impedance or adjusting a load on a power amplifier connected to the antenna towards a target impedance.

18. The wireless charger of claim 10, further comprising a variable capacitive divider coupled to the antenna, and wherein the processor is arranged to adjust the impedance of the antenna by adjusting the variable capacitive divider.
